(19) United States
(12) Patent Application Publication
(10) Pub. No.: US 2006/0201440 A1
(43) Pub. Date: Sep. 14, 2006

(54) Ventilated animal tote with protected filters and method of manufacturing thereof

(76) Inventor: Richard S. Phelan, Germantown, NY (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/365,488

(22) Filed: Mar. 2, 2006

Related U.S. Application Data
(60) Provisional application No. 60/659,409, filed on Mar. 9, 2005.

(51) Int. Cl. A01K 1/03

(52) U.S. Cl. 119/419

(57) ABSTRACT

An animal tote includes a container of thermoplastic material having a bottom wall and opposed side and end walls connected together to form an interior cavity having an open top covered by a lid. A plurality of arrays of spaced openings constituting air holes is formed in the walls and top. A layer of filter material and a protective layer of screen or mesh material, both constructed of a thermoplastic material, are positioned over the air holes and both layers are attached to the container by sonic welding. A divider system may be positioned in the cavity to form a plurality of separate inner compartments, with each compartment being closed by a separate cover. The container lid is positioned over the individual covers when the container is closed.

### BACKGROUND OF THE INVENTION

1. Field of the Invention

This invention relates to a ventilated tote or container for holding and transporting animals and, more particularly, to a ventilated animal tote with protected filters and having individually covered compartments for individually holding and transporting small laboratory animals such as rats, mice and other rodents.

2. Description of the Related Art

Totes or container of various types and sizes are known in the art for use in connection with shipping small animals such as rodents used for medical and experimental purposes. Air passages are provided in such animal totes to ventilate the interior of the container to permit the animals to breathe. The air passages may be covered with a filter material to prevent contaminated air from entering the container.

One example of such an animal tote is disclosed in U.S. Pat. No. 5,572,953 which discloses a unitary injection molded plastic container having a bottom wall, opposed side walls and opposed end walls with an open top covered by a lid. Air flow passages are formed in the lid and in one or more of the side and end walls, which may be covered with an air filter material. The interior of the container also may include dividers for dividing the interior into separate compartments.

Another container for transporting laboratory animals is disclosed in U.S. Pat. No. 6,588,373. This container has an open top covered by a lid having a passage through which at least one laboratory animal may pass during insertion into and extraction from the interior of the container. The side walls and the top include a plurality of air holes which are covered by a filter material heat welded to the container and protected by an outer filter guard mechanically attached to the container.

Another example of a container for shipping small animals is disclosed in U.S. Pat. No. 6,543,387. This patent discloses a container having an open top box divided into compartments by interior partitions. Air holes are provided in the lid and walls which are covered by a filter cloth. The lid includes two separate pivotal covers for the compartments inside of the container.

While the prior art containers are acceptable, there continues to be a need for compartmented containers which are provided with air holes covered by a filter material, which filter material in turn is protected from damage on its outer side by a protective guard layer. Moreover, there still is a need for an animal tote or container having a plurality of ventilated compartments inside, which are each provided with a separate cover for opening and closing each compartment.

### SUMMARY OF THE INVENTION

It is a an object of the present invention to provide a container having multiple interior covered compartments with air passages leading into the container through walls thereof that are covered with a filter material which in turn is covered by a protective layer such as a mesh or screen, with both the filter material and the protective layer being sonically welded to the container.

It is another object of the present invention to provide a stackable, molded plastic animal tote or container that has an interior divider system for forming a plurality of interior compartments, each of which has its own separate cover for opening and closing the compartment and wherein the container has a plurality of air holes in the sides and top which are covered by a filter layer which in turn is covered on its outer side by a protective layer of screen or mesh material sonically welded to the outside of the container.

It is still another object of the present invention to provide an improved method of manufacturing an animal tote or container having air holes in the walls and/or top whereby both a layer of filter material and an outer protective layer are constructed of thermoplastic material are attached to the container by sonic welding.

The present invention achieves the above and other objects by providing an animal tote comprising a container having a bottom wall, opposed side walls and opposed end walls connected together to form an interior cavity having an open top. A plurality of spaced openings constituting air holes are formed in at least one of the side walls and end walls and in the lid. The openings in each wall and lid are covered by a layer of filter material of suitable material such as a spun polypropylene blend which in turn is covered by a protective layer of screen or mesh material of suitable material such as polypropylene. Both the filter layer and the protective screen layer are constructed of a thermoplastic material and sonically welded to the container.

A divider system may be mounted in the cavity to form a plurality of separate interior compartments. A plurality of spaced openings are formed in at least certain of the dividers to provide air holes for each of the compartments. A separate openable cover is provided for each of the compartments. A lid is provided for covering the open top of the container and which is positioned over the individual covers for the compartments.

### BRIEF DESCRIPTION OF THE DRAWINGS

FIG. 1 is a perspective view of an animal tote according to the present invention;

FIG. 2 is an exploded perspective view of the animal tote of FIG. 1 showing the parts thereof;

FIG. 3 is a side view of the animal tote of FIG. 1 partially broken away to illustrate air holes covered by a filter layer under a protective layer;

FIG. 4 is a top plan view showing the animal tote of FIG. 1 partially broken away over one array of air holes to illustrate the lid of the animal tote with air holes covered by a filter layer under a protective layer and showing the other array of air holes uncovered;

FIG. 5 is a perspective view showing the body of the container and a system of dividers in a disassembled state; and

FIG. 6 is a top plan view showing the body of the container having a system of dividers mounted therein.

### DETAILED DESCRIPTION OF THE PREFERRED EMBODIMENTS

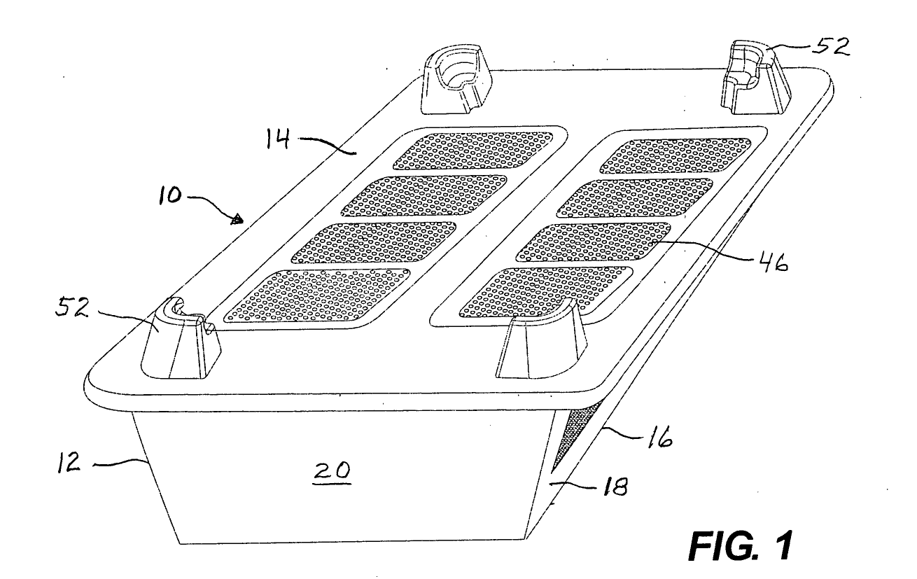

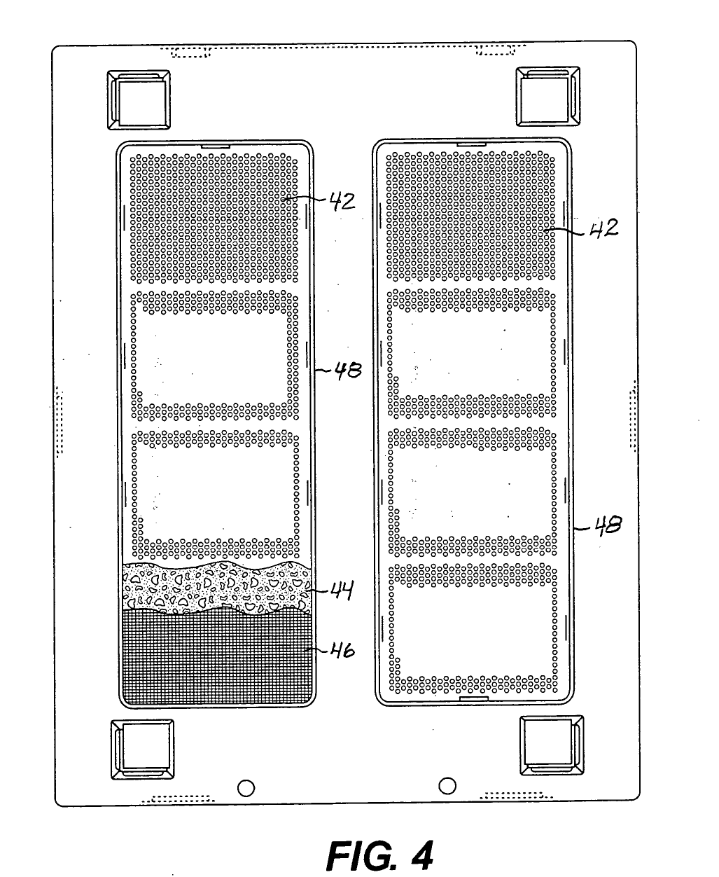

Illustrated in FIGS. 1-6 is an animal tote 10 according to the present invention. The animal tote 10 includes a container 12 having a lid 14 to cover the top thereof. Each tote preferably is molded separately of a rigid, high thermosetting plastic such as polypropylene having high flow characteristics and high heat stability characteristics. The container is of the same type as that illustrated and described in U.S. Pat. No. 5,572,953, which is incorporated herein by reference.

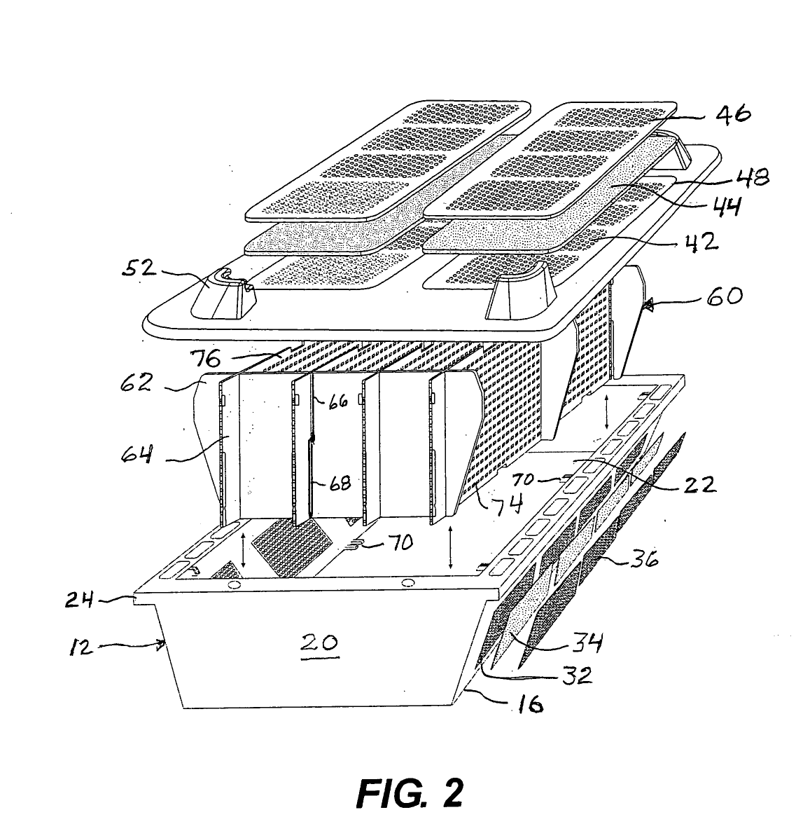

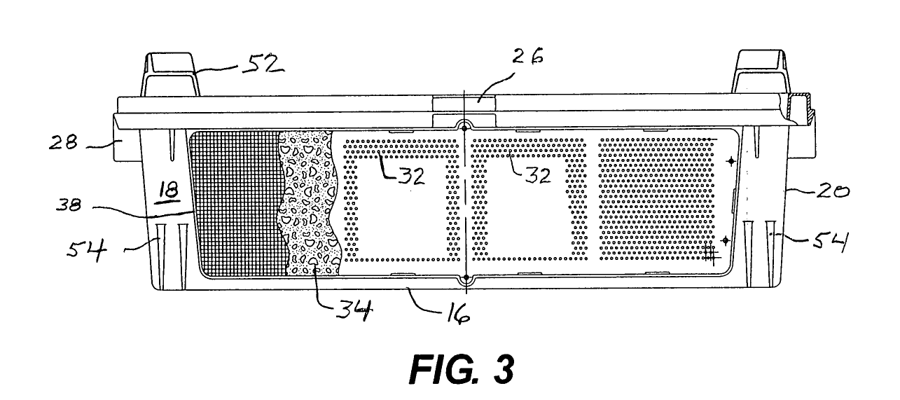

Each container 12 is constructed having a bottom wall 16, a pair of opposed side walls 18 and a pair of opposed end walls 20 connected together to form an interior cavity 22 having an open top. The container 12 has an outer lip or rim 24 extending around the edges of the top as shown in FIG. 2. The lid 14 is provided with a plurality of snap fitting flanges 26 which snap over the edge 24 to lock the lid in place over the container as shown in FIG. 3.

The side and end walls are sloped inwardly toward the bottom wall 16 from the open top of the container to permit nesting of similar containers when the lids are not in place. Flanges 28 located around the periphery of the container function as nesting stops when a plurality of containers is nested together in a vertical stack. Moreover, side walls 18 are slopped inwardly to a greater extent then required for nesting to provide, in combination with flanges 28, sufficient separation distance between adjacent totes when the totes are placed side by side either individually or in stacks. Accordingly, side by side separation is maintained to ensure adequate ventilation between adjacent containers.

To further provide adequate ventilation inside the container, the side walls 18 of the container are provided with arrays of minute holes 32 through which air may pass into the interior of the container as shown in FIG. 3. Although not shown in the drawings, one or both of the end walls 20 also may be provided with holes. To prevent contaminated air from entering the interior of the container through the holes 32, the holes are covered with a filter material 34 that is constructed of a suitable thermoplastic material such as polypropylene, as also shown in FIG. 3. The filters may be constructed of a spun polypropylene blend material and may also contain an antiseptic type material to kill germs on contact. The filter may be attached to the side walls by sonic welding.

Since the filter material is on the outside or exterior of the container, it is susceptible to damage during handling, shipping and the like, if not protected. Accordingly, a protective layer 36 of a suitable material preferably a screen or mesh material constructed of a thermoplastic such as polypropylene, is overlaid on the filter material 34. Both the filter material 34 and the protective layer overlaid thereon fit into a recess 38 formed in each side wall of the container with the recess also containing the arrays of holes 32.

By constructing both the filter material 34 and the protective layer 36 of screen or mesh material of a thermoplastic material such as polypropylene, both the filter material and the protective layer may be attached to the sidewall by sonic welding. Preferably, the filter layer and the protective layer are sonic welded to the container at the same time in a single operation. If desired, however, the filter layer and the protective layer may be individually sonic welded to the container in separate operations.

Sonic welding can be used to bond two or more thermoplastic materials together through the use of an ultra sonic frequency. This method is faster and more precise than conventional techniques and leaves no trace of a seam. Moreover, the sonic welding method is very clean and allows for a strong bond to be formed. Also, the filter layer and the protective layer may be sonic welded, at the same time, thus resulting in a more efficient operation.

In addition, as shown in FIGS. 1, 2 and 4, the lid is provided with a plurality of arrays of air holes 42 in recesses 48 formed in the lid. Air holes 42 also are covered with a filter material 44 and a layer of protective screen material 46 positioned in the recesses 48 and sonically welded to the lid.

The upper surface of the lid 14 is provided with upwardly extending stacking posts 52 adjacent the corners which are adapted to mate with outside corner flanges 54 of another identical container when two containers are stacked together. Since the stacking posts 52 extend above the surface of the lid and mate with the bottom portion of the corner flanges 54, when the totes are stacked in a vertical stack with the lids on, a separation distance is maintained between the top of one lid and the bottom wall of an adjacent stacked container. The maintaining of this vertical separation distance between two stacked totes further facilitates the passage of air into and out of the container.

As shown in FIGS. 2, 5 and 6, a system of dividers, generally indicated by the numeral 60, is adapted to fit snugly into the interior cavity 22 of each container 12. The system of dividers is comprised of a plurality of spaced widthwise walls 62 positioned in interlocking relationship with a plurality of spaced lengthwise walls 64. The widthwise walls 62 are provided with vertical slots 66 and the lengthwise walls 64 are provided with vertical slots 68, respectively, as shown in FIG. 2, whereby when the walls are formed into a system of dividers, the two sets of slots are connected in an interlocking relation.

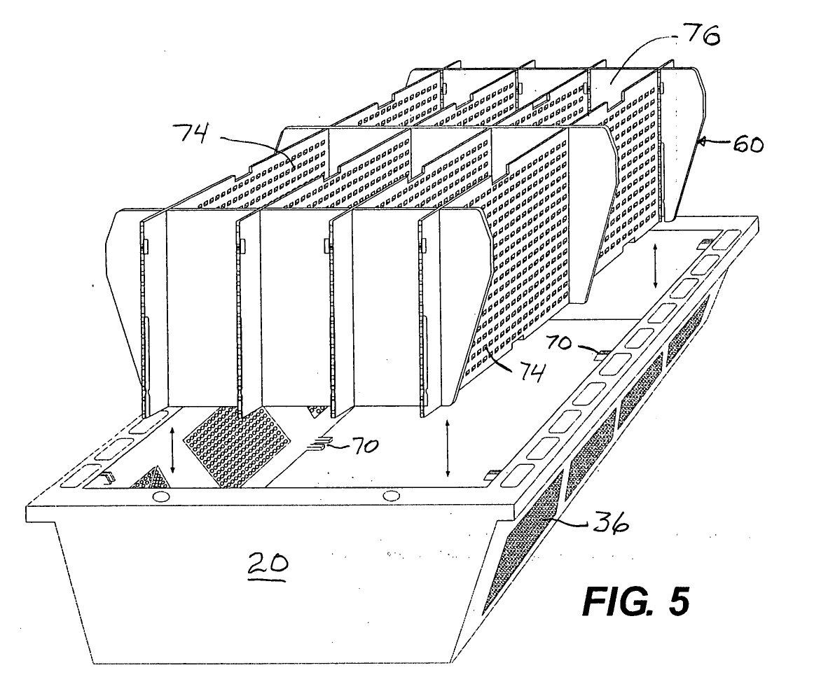

The outer ends of the widthwise walls 62 and the lengthwise walls 64 are slanted inwardly from the top to the bottom to conform to the slanting configuration of the side and end walls of the container 12. In addition, as shown in FIGS. 2 and 5, the container 12 may be provided with slots 70 spaced around the outer edges and on the inner portion of the bottom wall 22 to securely retain the system of dividers in the interior cavity of the container.

Either or both of the walls 62 and 64 may be provided with arrays of air holes 74 to permit ventilation between individual compartments 76.

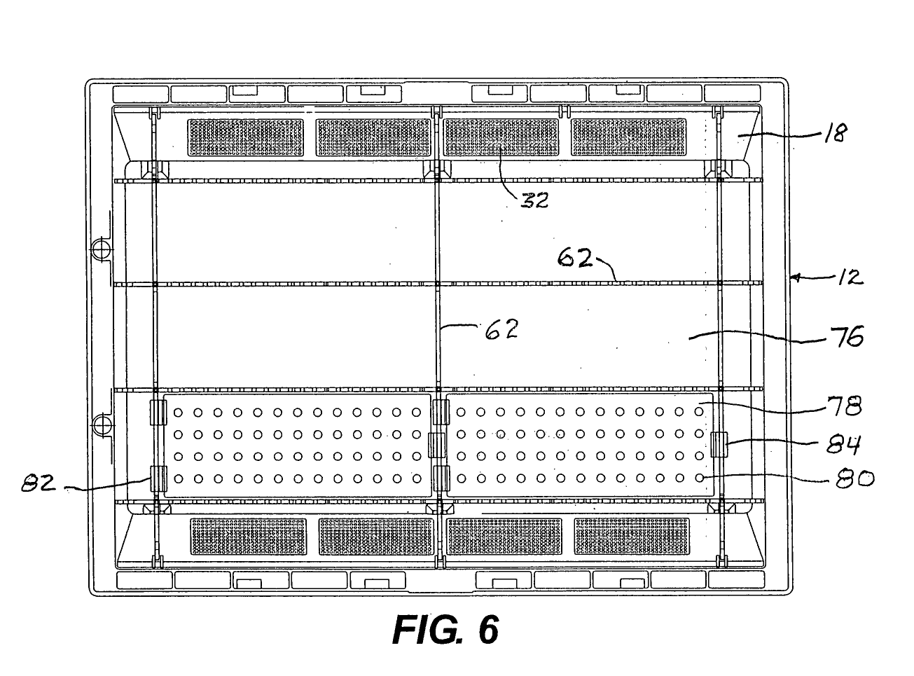

Each of the compartments 76 is provided with a cover 78 having a plurality of air holes 80 formed therein as shown in FIG. 6. While only two covers 78 are shown in FIG. 6, in the preferred embodiment, each of the individual compartments 76 is provided with a perforated cover 78. The covers over the compartments may be held in place in a number of suitable ways. Thus, as shown in FIG. 6, each cover 78 is connected by hinges 82 at one end and a snap connector 84 at an opposite end to connect to widthwise walls 62. Alternatively, both ends of each cover may be connected by snaps 84 or other latch means.

A significant advantage of forming a plurality of individually covered compartments in the container portion of each animal tote is that individual animals can be kept in individual compartments and the animals may be loaded or unloaded from the compartments one at a time without the remaining animals being freed. This is particularly advantageous when laboratory animals are involved since it is often desirable to have each of the animals separated from each other.

In another embodiment, the lid 14 of the animal tote may be utilized to hold the dividers covers in place by being placed right above the covers.

While the animal tote is shown incorporating a system of dividers, the animal tote also may be used without the dividers.

In constructing the animal tote 10 of the present invention, the container 12 and the lid 14 are molded separately of a high thermosetting plastic such as polypropylene. The container and lid are molded with the air holes therein. The array of air holes in the container and lid are then covered with a layer of filter material overlaid with a protective layer of screen or mesh material. The layers of filter and protective material are then attached to the container and the lid by sonic welding. The system of dividers having each compartment fitted with a separate cover is then inserted into the interior cavity of the container and the lid is put on the top of the container.

While preferred embodiments have been set forth with specific details, further embodiments, modifications and variations are contemplated according to the broader aspects of the present invention.

1. An animal tote comprising:
a container having a bottom wall, opposed side walls and opposed end walls connected together to form an interior cavity having an open top;
a lid for covering said open top of said container;
a plurality of spaced opening constituting air holes formed in said lid and in at least one of said side walls and end walls;
a filter layer of the thermoplastic material covering said spaced openings for filtering air flowing into the container through said openings, said filter layer being attached to the container by sonic welding; and
a protective layer of thermoplastic material covering said layer of filter material to protect said filter layer, said protective layer being attached to the container by sonic welding.

2. An animal tote according to claim 1 wherein said filter material is a spun thermoplastic material.

3. An animal tote according to claim 2 wherein said protective layer of thermoplastic material is a screen material.

4. An animal tote according to claim 3 which further comprises a plurality of divider walls mounted in said cavity to form a plurality of separate compartments therein.

5. An animal tote according to claim 4 which further comprises a separate openable cover for at least one of said compartments.

6. An animal tote according to claim 4 which further comprises a separate openable cover for each compartment.

7. A method of manufacturing an animal tote comprising the steps of:
constructing a container of thermoplastic material having a bottom wall, opposed side walls and opposed end walls connected together to form an interior cavity having an open top, at least one of said side walls and said end walls having a plurality of spaced openings therein constituting air holes;
forming a lid for covering said open top, said lid having a plurality of spaced openings therein constituting air holes;
covering said spaced openings in said at least one of said side walls and said end walls and said lid with a filter layer of thermoplastic material;
covering said filter layer with a protective layer of thermoplastic material; and
sonic welding said filter layer and said protective layer simultaneously to said container.

8. An animal tote according to claim 7 wherein said filter material is a spun thermoplastic material.

9. An animal tote according to claim 8 wherein said protective layer of thermoplastic material is a screen material.

10. An animal tote according to claim 9 which further comprises the step of mounting a plurality of divider walls in said cavity to form a plurality of compartments therein.

11. An animal tote according to claim 10 which further comprises the step of mounting a separately openable cover on at least one of said compartments.

12. An animal tote according to claim 10 which further comprises the step of mounting a separately openable cover on each of said compartments.
